(19) United States
(12) Patent Application Publication
(10) Pub. No.: US 2023/0301748 A1
(43) Pub. Date: Sep. 28, 2023

(54) DENTAL EXTRACTION INSTRUMENT

(71) Applicant: Michihiro Iwashiro, Souraku-gun (JP)

(72) Inventor: Michihiro Iwashiro, Souraku-gun (JP)

(21) Appl. No.: 18/124,323

(22) Filed: Mar. 21, 2023

(30) Foreign Application Priority Data
Mar. 22, 2022 (JP) 2022-045485

(51) Int. Cl. A61C 3/14

(52) U.S. Cl. CPC A61C 3/14

(57) ABSTRACT

A dental extraction instrument that is applicable to tooth roots of various shapes and sizes and that enables quick tooth extraction and reduces the burden on the patient. It includes a gripper, a shank extending from the gripper, and a head at the distal end of the shank to be inserted into a periodontal space for extraction of a tooth using a lever effect. The head bifurcates in plan view, and has two sharp prongs and a web between the prongs. The web connects the prongs that are extending in a direction away from the shank and is axially recessed from the distal ends of the prongs. The web has a biconcave shape in the center to be thinner than the prongs as viewed in the cross section perpendicular to the shank.

### BACKGROUND OF THE INVENTION

### 1. Field of the Invention

The present invention relates to a dental extraction instrument used in dental practice.

### 2. Description of the Related Art

A dental instrument called an elevator, or hebel as traditionally referred to in the Japanese dental industry, has a gripper to be gripped by a hand, a head to be inserted into a periodontal space, and a shank that connects the gripper and the head to allow force transmission; it is a tool used to rock the root of a tooth back and forth using the principle of leverage and to elevate the root in the end to allow the tooth to be extracted. Unlike forceps, elevators provide the advantage of enabling extraction of residual tooth roots or teeth that are difficult to extract. The gripper is usually made thick and provided with various design features for easier force application. The shank is narrow and long to avoid interference with neighboring teeth as much as possible.

Commercially available elevators have a head with a round tip, with the center of the round tip shaped to fit into a deepest part of a periodontal space.

Improvements to such design have been proposed and elevators with a U-shaped or V-shaped head are also commercially available (Japanese Utility Model Application Publication No. S56-80110), which claim to be able to hold a tooth root with two prongs of the head.

### SUMMARY OF THE INVENTION

When used to move a tooth back and forth or to elevate the tooth, the head of the commercially available elevators tends to slip due to poor engagement between the head and the tooth root as also described in Japanese Utility Model Application Publication No. S56-80110. As a result, the tooth extraction takes a long time and places a high burden on the patient. The elevator proposed in Japanese Utility Model Application Publication No. S56-80110 is not always able either to make close contact with and tightly hold a tooth root that comes in various shapes and sizes. While the periodontal space surrounding a tooth root is circumferentially curved, the elevator according to Japanese Utility Model Application Publication No. S56-80110 is flat in lateral cross section as described from the last line on page 4 to the second line on page 5. Often, the head can not be inserted easily, with a portion on its outer circumferential surface, i.e., a ventral or dorsal portion, compressing the periodontal ligament or neighboring bone. It is therefore the conventional practice in tooth extraction to use several types of elevators in accordance with the tooth shape, taking a long time in the insertion process and imposing a burden on the patient.

Accordingly, an object of this invention is to provide a dental extraction instrument that is applicable to tooth roots of various shapes and sizes and that enables quick tooth extraction and reduces the burden on the patient.

Accordingly, a dental extraction instrument of this invention includes a gripper, a shank extending from the gripper, and a head at a distal end of the shank to be inserted into a periodontal space for extraction of a tooth using a lever effect.

The head bifurcates in a plan view, and includes two sharp prongs extending in a direction away from the shank and a web between the prongs and connecting the prongs. The web is axially recessed from the distal ends of the prongs and is biconcave so that it is thinner than the prongs when viewed in a cross-section perpendicular to the shank.

To use this dental extraction instrument according to the invention, the gripper is gripped, and the prongs are inserted into a periodontal space first. It is also possible to insert only one of the two prongs because of its bifurcation. The prongs are sharp enough to be inserted easily. The first and second prongs allow any protrusion on the periodontal ligament or the bone to be positioned between them so that the two prongs can readily enter without interfering with the protrusion even if the periodontal space is of an irregular shape. The web connecting the prongs together prevents the thin prongs from breaking. Moreover, the web is axially recessed from the distal ends of the prongs, and has a small thickness, being biconcave, so that the head can be inserted deeply without interference with protrusions on the periodontal ligament or the bone.

In any case, the second prong can be elevated by the principle of leverage, using the first prong as a fulcrum. Normally, the second prong is then rotated back and forth about the axis, with the first prong serving as the fulcrum. This widens the periodontal space and facilitates the operation. The prong end advances further into the space and elevates the root gradually to allow tooth extraction with a small force. With this dental extraction instrument according to the invention, either the first and second prong bites into either the bone or the periodontal ligament respectively so that no slippage occurs when used in a rocking motion. The tooth can then be extracted by rotating the second prong largely and elevating the second prong with the root, using the first prong as the fulcrum.

The web is concave in a direction perpendicular to the shank. The concave is preferably becoming deeper away from the shank both on the top side and the bottom side and being curved as viewed in the cross-section perpendicular to the shank. This allows both the dorsal and ventral sides of the head to conform to a protrusion on the tooth root or the bone and makes the insertion even easier.

A preferable prong would have angles α and β both being not greater than 30°. The α is the angle between lines “a” and “b” respectively tangent to an outer and inner contour of the prong in the plan view. The β is the angle between lines “c” and “d” respectively tangent to a contour on the top side and on the bottom side of the prong in the front view. This degree of sharpness can reliably provide the above-described effects in the insertion and engagement processes.

The two prongs are normally spaced apart at their distal ends by 2 to 6 mm. There is a distance of 5 to 15 mm from the midpoint between the distal ends of the prongs to a distal end of the shank, and a distance of 2 to 7 mm between the midpoint and a distal edge of the web. The head in these ranges can be applied to tooth roots of various shapes and sizes while maintaining the necessary strength.

The shank preferably includes a recess that is curved in front view on a top outer face continuous with or close to the head. With an index finger resting on this recess during the insertion operation, an accidental insertion into a wrong site can be prevented. The recess also allows inexperienced dentists to learn the correct way of holding the instrument.

The gripper is preferably made up of a body having a large diameter and a shoulder located between the body and the shank. The shoulder has an intermediate diameter that is between the body diameter and the shank diameter. The shoulder is provided with a chamfer on an edge on the top side. Resting an index finger on this chamfer during the elevation operation can help prevent accidents as with the insertion operation, and makes it easy to learn the correct way of holding the instrument.

As described above, the dental extraction instrument according to this invention, with the two sharp prongs on the head, can be applied to tooth roots of various shapes and sizes. In addition, the instrument enables quick tooth extraction and can thereby reduce the burden on the patient.

### BRIEF DESCRIPTION OF THE DRAWINGS

FIG. 1A is a top plan view, FIG. 1B is a front view, FIG. 1C is a bottom plan view, FIG. 1D is a left side view, and FIG. 1E is a right side view of a dental extraction instrument of Embodiment 1;

FIG. 2 is an enlarged plan view of the head and its vicinity of the dental extraction instrument;

FIG. 3A to FIG. 3G are respective cross-sectional views of lines A-A′, B-B′, C-C′, D-D′, E-E′, F-F′, and G-G′ in FIG. 2;

FIG. 4 is a plan view explaining the sharpness of the prong;

FIG. 5 is a front view of same;

FIG. 6A and FIG. 6B are perspective views illustrating how the dental extraction instrument of Embodiment 1 is used, FIG. 6A in particular showing an insertion operation and FIG. 6B in particular showing a rocking and elevating operation; and

FIG. 7 is a horizontal cross-sectional view illustrating a condition in which the dental extraction instrument is inserted into a periodontal space.

### DESCRIPTION OF THE PREFERRED EMBODIMENTS

### Embodiment 1

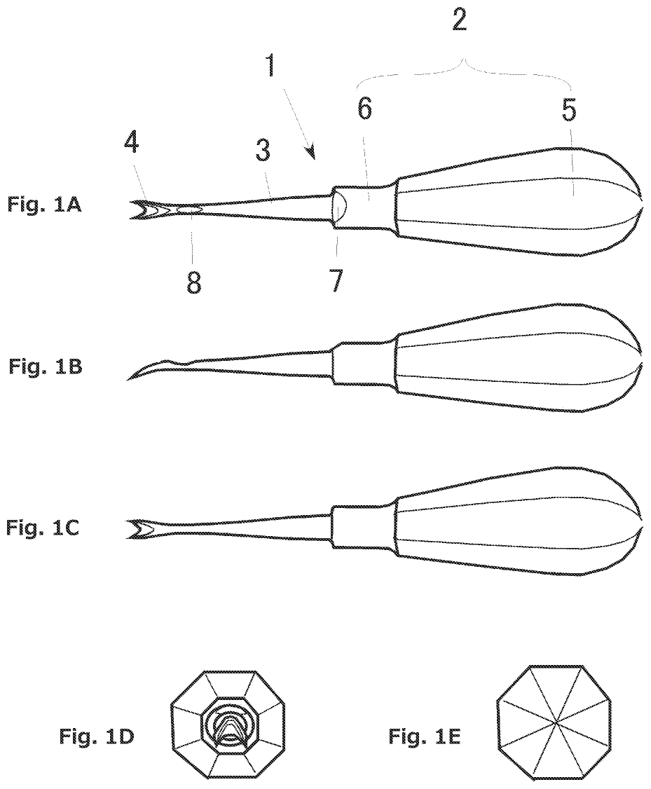

The dental extraction instrument 1 according to a first embodiment is entirely made of a biologically non-toxic, corrosion-resistant metal such as for example stainless steel, cobalt-chromium alloy, or titanium alloy, and includes a gripper 2, a shank 3 extending straight from the gripper 2, and a head 4 at the tip of the shank 3 as shown in FIG. 1A to FIG. 1E. The gripper 2 is made up of a body 5 and a shoulder 6. The body 5 is octagonal in cross section of a plane perpendicular to the shank 3 and about 6 cm in axial length, with an evenly bulging middle portion having a maximal length of a diagonal of about 30 mm. The shoulder 6, continuous with the body 5, is circular in cross section with a diameter of about 10 mm, and about 15 mm in length. The body 5 is hollowed out to reduce weight. The shank 3 extends from the shoulder 6. An edge on the top side of the shoulder 6 is chamfered (as denoted at 7) toward the shank 3. The shank 3 is circular in cross section, and becomes narrower towards the end, its diameter being about 5 mm at its starting point continuing from the shoulder 6, and about 3 mm near the head 4. A recess 8 of about 1 mm in depth, curved in front view, is provided on an outer face on the top side of the shank connecting to the head 4.

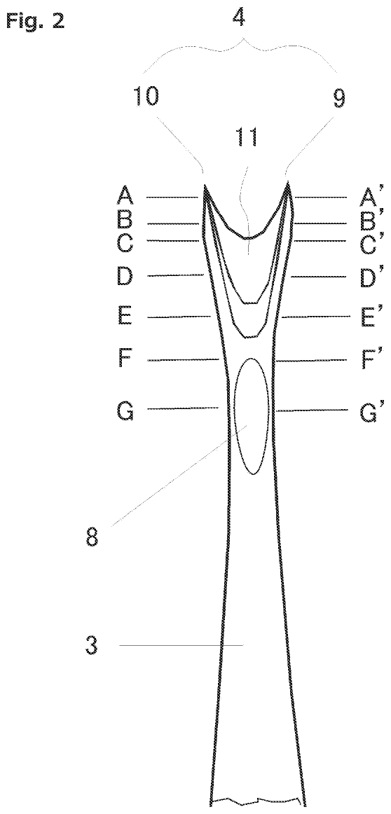

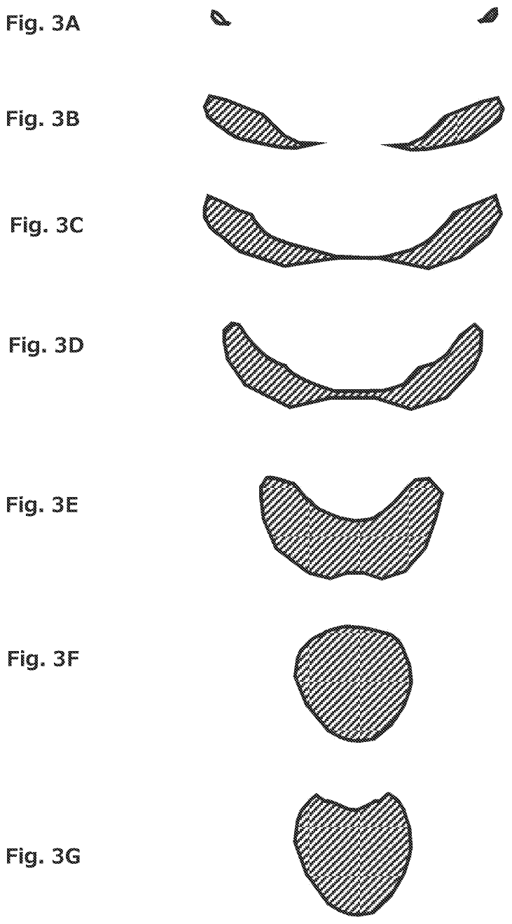

The head 4 is bent at about 30° relative to the shank 3 toward the bottom side in front view, and in a “U” or “V” shape symmetrical about the axis in plan view as shown in FIG. 2, with two integrally formed prongs 9 and 10 and a web 11. The prongs 9 and 10 bifurcating from the shank 3 extend in directions away from the shank in plan view and each of them has a sharp pointed end. The distance between the prongs 9 and 10, which increases towards the end, is 4 mm at the distal end. The web 11 between the prongs 9 and 10 connects the prongs as can be likened to a web between fingers. As shown in FIG. 3B to FIG. 3E, the web is concave both on the top side and the bottom side to be thinner than the prongs 9 and 10 as viewed in cross sections perpendicular to the shank 3. The concave on both sides of the web 11 becomes deeper away from the shank 3 and is curved as viewed in cross sections perpendicular to the shank 3. The distance from the midpoint between the distal ends of the prongs 9 and 10 to the distal end of the shank 3, i.e., the starting point of the web 11, is 10 mm, and the distance between the midpoint and the distal edge of the web 11 is 3 mm.

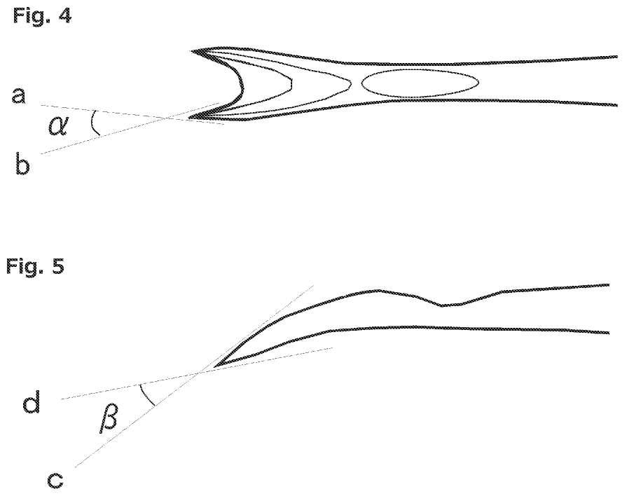

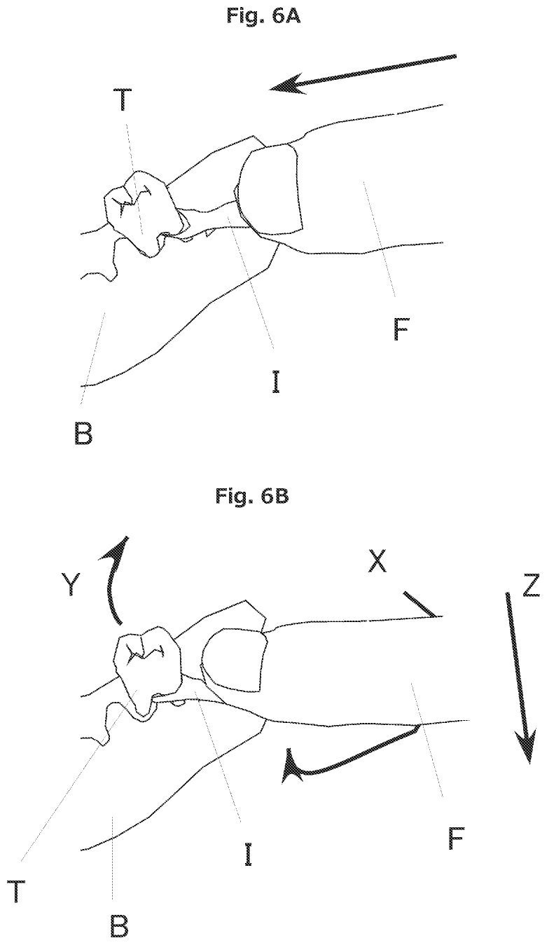

The prong 9 is so sharp as to have angles α and β shown in FIG. 4 and FIG. 5 both being not greater than 30°, α being the angle between line “a” tangent to an outer contour of the prong 9 and line “b” similarly tangent to an inner contour in plan view as shown in FIG. 4, and β being the angle between line “c” tangent to a contour on the top side of the prong 9 and line “d” similarly tangent to a contour on the bottom side in front view as shown in FIG. 5. The same applies to the prong 10.

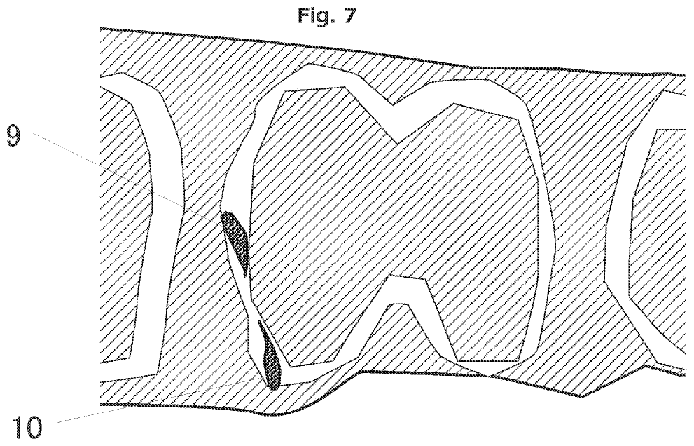

When in use, the gripper 2 of the dental extraction instrument 1 is held with the body 5 wrapped in the palm and the shoulder 6 held between the thumb and the middle finger, and with the index finger F rested on the recess 8 as shown in FIG. 6A. The prongs 9 and 10 are first inserted into a periodontal space or a gap between a tooth root T and alveolar bone B, the prong 9 engaging the tooth root T and the prong 10 engaging the alveolar bone B. The prongs are sharp enough to allow easy insertion, and the index finger F rested on the recess 8 continuous with the head 4 facilitates accurate movement of the head 4. Therefore, even if the head slips and tries to advance to a position different from a target engagement site, the head can be stopped by the index finger, and thus malpractice by accidental insertion of the prongs into a wrong site can be prevented. The prongs 9 and 10 allow any protrusion on the root or the bone to be positioned between them as shown in FIG. 7 so that the two prongs can readily enter without interfering with the protrusion even if the periodontal space is of an irregular shape. The web 11 connecting the prongs 9 and 10 together prevents the thin prongs from breaking. Moreover, the web 11 is axially recessed from the distal ends of the prongs 9 and 10, as well as concave both on the top side and the bottom side, so that the head can be inserted deeply without interference with protrusions on the periodontal ligament or the bone.

Next, the prong 10 closer to the center of the root is rotated back and forth about the axis as indicated by arrow X in FIG. 6B, using the prong 9 inserted away from the center of the root as a fulcrum. This widens the periodontal space and facilitates the operation, as well as elevates the tooth root T gradually to allow tooth extraction with a small force. With the prongs 9 and 10 biting into the bone B and the tooth root T respectively, the tooth can be rocked in a reliable manner without slippage of the prongs 9 and 10 on the bone B or the tooth root T. The tooth can then be extracted by rotating the prong 10 largely to elevate the tooth using the principle of leverage as indicated by arrows Y and Z in FIG. 6B with the prong 9 serving as the fulcrum.

As described above, the dental extraction instrument 1 allows both rocking and elevating operations to be performed with itself alone and obviates the need to change instruments for each operation. In both of these operations, the sharp prongs 9 and 10 biting into the tooth root T or alveolar bone B prevent slippage. The instrument thus allows quick tooth extraction.

Depending on the circumstances, for example when the tooth root T is already elevated to a considerable extent, only one of the two prongs 9 and 10 or bifurcated ends may be inserted in the first place. With the index finger F rested on the chamfer 7, it is easier to gradually lower the gripper 2 during the elevating operation, which can prevent an accidental breakage of the tooth that may be caused by a hurried attempt to extract the tooth when the root is not sufficiently lifted up yet. Moreover, since the head 4 is bent toward the bottom side relative to the shank 3 at about 30° in front view in this embodiment, the head 4 can be inserted into a periodontal space on the far side of a tooth such that the front side of the head 4 faces the alveolar bone and the bottom side of the head 4 faces the periodontal ligament.

### Embodiment 2

The dental extraction instrument according to a second embodiment is of the same shape and material as that of the first embodiment except for a smaller head suited to a tooth with a small root cross-sectional diameter, with the distance between the distal ends of the prongs being 3 mm, the distance between the midpoint between the distal ends of the prongs and a distal end of the shank being 5 mm, and the distance between the midpoint between the distal ends of the prongs and a distal edge of the web being 2 mm.

What is claimed is:

1. A dental extraction instrument comprising:
a gripper;
a shank extending from the gripper; and
a head at a distal end of the shank to be inserted into a periodontal space for extraction of a tooth using a lever effect;
wherein the head bifurcates in plan view, and has two sharp prongs and a web between the prongs and connecting the prongs, the prongs extending in a direction away from the shank, and the web being axially recessed from distal ends of the prongs and biconcave to be thinner than the prongs as viewed in cross section perpendicular to the shank.

2. The dental extraction instrument according to claim 1, wherein the concave becomes deeper away from the shank both on the top side and the bottom side and being curved as viewed in cross section perpendicular to the shank.

3. The dental extraction instrument according to claim 1, wherein each of the prongs has angles α and β both being not greater than 30°, α being the angle between lines “a” and “b” respectively tangent to an outer and inner contour of the prong in plan view, and β being the angle between lines “c” and “d” respectively tangent to a contour on the top side and on the bottom side of the prong in front view.

4. The dental extraction instrument according to claim 1, wherein the two prongs are spaced apart at their distal ends by 2 to 6 mm, and have a distance of 5 to 15 mm from the midpoint between the distal ends of the prongs to a distal end of the shank, and a distance of 2 to 7 mm between the midpoint and a distal edge of the web.

5. The dental extraction instrument according to claim 1, wherein the shank includes a recess that is curved in front view on a top outer face continuous with or close to the head.

6. The dental extraction instrument according to claim 1, wherein the gripper is made up of a body having a large diameter, and a shoulder located between the body and the shank and having an intermediate diameter that is between the body diameter and the shank diameter, the shoulder being provided with a chamfer on an edge on the top side.
